(19) United States
(12) Patent Application Publication
(10) Pub. No.: US 2022/0344657 A1
(43) Pub. Date: Oct. 27, 2022

(54) A POSITIVE ELECTRODE ACTIVE MATERIAL MANUFACTURING METHOD THEREOF, AND LITHIUM SECONDARY BATTERY COMPRISING THE SAME

(71) Applicants: POSCO, Pohang-si, Gyeongsangbuk-do (KR); RESEARCH INSTITUTE OF INDUSTRIAL SCIENCE & TECHNOLOGY, Pohang-si, Gyeongsangbuk-do (KR); POSCO CHEMICAL CO., LTD, Pohang-si, Gyeongsangbuk-do (KR)

(72) Inventors: Kwon Young CHOI, Seoul (KR); Inchul PARK, Incheon (KR); Jong ll PARK, Pohang-si, (KR); Jung Woo PARK, Incheon (KR); Young Sang KIM, Incheon (KR); Sang Cheol NAM, Seoul (KR)

(73) Assignees: POSCO, Pohang-si, Gyeongsangbuk-do (KR); RESEARCH INSTITUTE OF INDUSTRIAL SCIENCE & TECHNOLOGY, Pohang-si, Gyeongsangbuk-do (KR); POSCO CHEMICAL CO., LTD, Pohang-si, Gyeongsangbuk-do (KR)

(21) Appl. No.: 17/763,365

(22) PCT Filed: Sep. 23, 2020
(86) PCT No.: PCT/KR2020/012848

§ 371 Date: May 11, 2022

(30) Foreign Application Priority Data
Sep. 24, 2019 (KR) 10-2019-0117298

(51) Int. Cl. H01M 4/525; H01M 4/04

(52) U.S. Cl. CPC H01M 4/525; H01M 4/0471; H01M 2004/028

(57) ABSTRACT

The present exemplary embodiments relate to a positive electrode active material, a manufacturing method thereof, and a lithium secondary battery including the same.

According to an exemplary embodiment, it is possible to provide a positive electrode active material containing: a lithium metal oxide, and a coating layer positioned on the surface of the lithium metal oxide, and the coating layer comprises a first compound having a peak observed in the range of 1580 cm⁻¹ to 1600 cm⁻¹ when measured by FT-IR and an average transmittance of the peak in the 0.990 to 0.998 range.

### BACKGROUND OF THE INVENTION

### (a) Field of the Invention

It is related that a positive electrode active material, its manufacturing method, and a lithium secondary battery including the same.

### (b) Description of the Related Art

Recently, there is an explosive increase in demand for IT mobile devices and small electric power devices (e-bikes, small EVs, etc.), and there is a demand for electric vehicles with a driving distance of 400 km or more. Accordingly, the development of secondary batteries having high-capacity and a high energy density to drive them is being actively conducted worldwide.

In order to manufacture such a high-capacity battery, it is necessary to use a high-capacity positive electrode active material.

Among the existing layered positive electrode active materials, the highest capacity material is LiNiO₂ (275 mAh/g). However, structural collapse occurs easily during charging and discharging, and thermal stability due to oxidation number problem is low, making it difficult to commercially available.

In order to solve this problem, it is necessary to substitute other stable transition metals (Co, Mn, etc.) for the unstable Ni site. For this purpose, a ternary NCM system in which Co and Mn are substituted has been developed.

However, in the case of ternary NCM, thermal safety decreases as the Ni content increases.

The above information disclosed in this Background section is only for enhancement of understanding of the background of the invention, and therefore it may contain information that does not form the prior art that is already known in this country to a person of ordinary skill in the art.

### SUMMARY OF THE INVENTION

In the present exemplary embodiment, it is intended to provide a positive electrode active material that suppresses the decomposition reaction of the electrolyte solution on the surface. Accordingly, the cycle-characteristic at high temperature can also be improved.

The positive electrode active material according to an exemplary embodiment can comprises:

a lithium metal oxide; and a coating layer positioned on a surface of the lithium metal oxide; wherein, the coating layer includes a first compound whose average transmittance of a peak, which is observed in the range of 1580 cm⁻¹ to 1600 cm⁻¹ by FT-IR measurement, is in the range of 0.990 to 0.998.

The manufacturing method of the positive electrode active material according to another exemplary embodiment can comprises:

preparing a lithium metal oxide; and

forming a coating layer on a surface of the lithium metal oxide;

wherein, the coating layer includes a first compound whose average transmittance of a peak, which is observed in the range of 1580 cm⁻¹ to 1600 cm⁻¹ by FT-IR measurement, is in the range of 0.990 to 0.998.

The positive electrode active material according to an exemplary embodiment may form a coating layer including a compound including a carbon-nitrogen bond on the surface of lithium metal oxide particles. This coating layer comes into contact with the electrolyte solution. The decomposition reaction of the electrolyte solution on the positive electrode surface can be suppressed by the action of the compound containing the carbon-nitrogen bond included in the coating layer.

Due to this reduction of the electrolyte solution side reaction, the cycle-characteristic of the positive electrode active material at a high temperature can be significantly improved.

### BRIEF DESCRIPTION OF THE DRAWINGS

FIG. 1 is an FT-IR analysis result for a positive electrode active material manufactured according to exemplary embodiment 1 to 2 and Comparative Example 1.

FIG. 2A to FIG. 2C and FIG. 3A to FIG. 3C is an XPS analysis result for the positive electrode active material manufactured according to exemplary embodiment 1 and exemplary embodiments 6 to 7.

FIG. 4 shows the evaluation result of the high temperature cycle-life characteristic for the lithium secondary battery to which the positive electrode active material manufactured according to Comparative Example 1, exemplary embodiment 1 and 2 is applied.

### DETAILED DESCRIPTION OF THE EMBODIMENTS

Hereinafter, an embodiment of the present invention will be described in detail. However, this is provided as an example, and the present invention is not limited thereto, and the present invention is only defined by the scope of claims to be described later.

The positive electrode active material according to an exemplary embodiment includes lithium metal oxide and a coating layer positioned on the surface of the lithium metal oxide.

In the present exemplary embodiment, the coating layer may include a first compound in which a peak is observed in the range of 1580 cm⁻¹ to 1600 cm⁻¹ by FT-IR measurement. In addition, in the first compound, the average transmittance of the peak in the wavelength range may be in the 0.990 to 0.998 range, more specifically in the 0.993 to 0.995 range. When the wavelength range where the peak of the first compound is observed by FT-IR measurement and the average value of transmittance satisfy the range, the electrolyte solution decomposition reaction on the surface of the positive electrode active material can be effectively suppressed. Accordingly, it is possible to significantly improve the high temperature cycle-life characteristic of the lithium secondary battery to which the positive electrode active material of the present exemplary embodiment is applied.

Meanwhile, the coating layer may further include a second compound whose peak is observed in the range of 1070 cm⁻¹ to 1120 cm⁻¹ when measured by FT-IR, more specifically, in the range of 1085 cm⁻¹ to 1105 cm⁻¹. In addition, the second compound may have an average transmittance of the peak in the wavelength range of 0.985 to 0.993 range, more specifically 0.987 to 0.993 range. When the wavelength range where the peak of the second compound is observed during FT-IR measurement and the average value of transmittance satisfy the range, the electrolyte solution decomposition reaction on the surface of the positive electrode active material can be effectively suppressed. Accordingly, it is possible to significantly improve the high temperature cycle-life characteristic of the lithium secondary battery to which the positive electrode active material of the present exemplary embodiment is applied.

When A is the value obtained by dividing the absorbance average of the first compound by the absorbance average of the second compound, A may satisfy Equation 1 below.

0.72>A=(absorbance average of a first compound)/(absorbance average of a second compound)>0.41 [Equation 1]

More specifically, the A value may be in the range 0.72>A>0.22 or 0.8>A>0.22. If the A value satisfies the range, the electrolyte solution decomposition reaction on the surface of the positive electrode active material can be effectively suppressed. Accordingly, it is possible to significantly improve the high temperature cycle-life characteristic of the lithium secondary battery to which the positive electrode active material of the present exemplary embodiment is applied.

The first compound may be, for example, a compound including a CN bond.

The second compound may be, for example, a compound including a SOx bond. In this case, the SOx bond may be an SO₃ or SO₄ bond.

When a coating layer containing the first and second compounds of the same type as described above is formed on the surface of lithium metal oxide, it is possible to suppress side reaction with the electrolyte solution and make a positive electrode active material with increased high temperature cycle-life characteristic.

The coating layer, in a spectrum measured by X-ray photoelectron spectroscopy (XPS), for example, a peak can be observed in at least one of 398 eV to 404 eV range, 166 eV to 173 eV range and 158 eV to 166 eV range. This is a result of the inclusion of a compound containing a CN bond and/or a compound containing a SOx bond in the coating layer.

The positive electrode active material may have an average grain size (crystalline size, Lc) of 111 nm to 140 nm, more specifically, 115 nm to 120 nm range. When the average grain size of the positive electrode active material satisfies the range, the capacity retention characteristic at high temperature can be improved.

On the other hand, the average particle size D50 of the positive electrode active material according to the present exemplary embodiment may be 5 μm to 20 μm, more specifically 10 μm to 20 μm range.

In addition, the specific surface area of the positive electrode active material may be in the range of 0.3 to 1.5 m²/g, more specifically, 0.5 to 1.5 m²/g or 0.96 to 1.5 m²/g.

Meanwhile, in the present exemplary embodiment, the content of nickel in the metal in the lithium metal oxide may be 80 mol % or more. More specifically, the lithium metal oxide may be represented by, for example, Chemical Formula 1 below.

LiₓNiₐCo_{b}Mn_{c}M1_{d}M2ₑO₂ [Chemical Formula 1]

In the Chemical Formula 1, M1 and M2 are at least one of Zr, Ti, Mg, Al, Ni, Mn, Zn, Fe, Cr, Mo and W, respectively,

x is 0.90≤x≤1.07, a is 0.80≤a<1, b is 0<b≤0.3, c is 0<c≤0.3, d is 0<d<0.01, e is 0<e<0.01,and a+b+c+d+e=1.

In this case, the a may be 0.85≤a<1, more specifically, 0.90≤a<1.

Also, the b may be 0<b≤0.2 or 0<b≤0.1, and c may be 0<c≤0.2 or 0<c≤0.1.

In addition, the M1 may be Zr, and the M2 may be Al. When M1 is Zr and M2 is Al, the positive electrode active material of the present exemplary embodiment may include 0.05 parts by weight to 0.6 parts by weight of Zr based on the entire lithium metal oxide. In addition, Al may be included in the range of 0.01 to 0.4 parts by weight.

As in the present exemplary embodiment, when the content of nickel in the metal in lithium metal oxide is 80% or more, that is, when a is 0.80 or more in Chemical Formula 1, a positive electrode active material having a high-power characteristic can be implemented. Since the positive electrode active material of the present exemplary embodiment having such a composition increases the energy density per volume, it is possible to improve the capacity of the battery to which it is applied, and it is also suitable for use for electric vehicles.

A manufacturing method of a positive electrode active material according to another exemplary embodiment may include preparing lithium metal oxide and forming a coating layer on a surface of the lithium metal oxide.

In this case, the coating layer may include a first compound in which a peak is observed at 1580 cm⁻¹ to 1600 cm⁻¹ by FT-IR measurement, and the average transmittance of the peak is in the 0.990 to 0.998 range.

In addition, the coating layer may further include a second compound in which a peak is observed in the range of 1070 cm⁻¹ to 1120 cm⁻¹ by FT-IR measurement, and the average transmittance of the peak is in the range of 0.985 to 0.993.

In the present exemplary embodiment, the characteristics regarding the coating layer are the same as the positive electrode active material according to the above-described an exemplary embodiment. Therefore, since this has been described in detail in the positive electrode active material according to an exemplary embodiment, it will be omitted here.

The step of preparing the lithium metal oxide may be performed by a conventional method. For example, as described in the following exemplary embodiment, lithium metal oxide can be obtained by preparing a precursor of lithium metal oxide, mixing it with a doping raw material, and sintering, cooling, and pulverization.

Next, a step of forming a coating layer on the surface of the lithium metal oxide may be performed. In this case, the step of forming the coating layer may include washing the lithium metal oxide with water. More specifically, the washing with water may be performed using a washing solution including water and an additive for forming the coating layer.

The additive may be, for example, at least one of ammonium sulfate, ammonium cobalt sulfate hexahydrate, ammonium nickel sulfate, ammonium manganese sulfate and aluminum ammonium sulfate.

The additive in the washing solution chemically reacts with Li₂CO₃ dissolved from lithium metal oxide during cleaning, and a coating layer including CN bond and SO bond can be formed on the surface of lithium metal oxide through heat treatment. Therefore, the battery employing a positive electrode active material manufactured by the same method as the present exemplary embodiment, a coating layer containing a compound having a CN bond and/or a compound having a SOx bond is formed, can have a significantly improved high temperature cycle-life characteristic.

The content of the additive may be in the range of 1 wt % to 7 wt %, more specifically 1 wt % to 5 wt %, based on the washing solution. When the content of the additive is 1 wt % or more, the high temperature cycle-life characteristic can be significantly improved. In addition, if the content of the additive in the washing solution is 7 wt % or less, the performance for a lithium secondary battery to which the positive electrode active material of the present exemplary embodiment is applied can be further improved by significantly reducing the initial resistance at room temperature.

In addition, in the water washing process, the lithium metal oxide:washing solution as a content ratio and weight ratio may be used in a 1:1 to 3:1 range.

In the present exemplary embodiment, after the step of washing the lithium metal oxide with water, the method may further include a step of heat treatment after drying the washed lithium metal oxide.

Drying of the washed lithium metal oxide can be performed for 1 hour to 30 hours at a temperature range of 80° C. to 200° C. This is a sufficient temperature and time range to remove moisture, etc. remaining on the surface of the positive electrode active material treated with the washing solution, but is not limited thereto.

Next, the heat treatment of the washed lithium metal oxide may be performed, for example, in a temperature range of 300 to 700° C., more specifically, 400 to 600° C., for 3 to 10 hours. In addition, it may be carried out in an atmosphere of air, oxygen (O₂) or nitrogen (N₂). In the present exemplary embodiment, when the heat treatment temperature satisfies the range, there is an advantage that the high temperature cycle-life characteristic can be significantly improved.

These process conditions will be described in more detail in an exemplary embodiment to be described later.

In another embodiment of the present invention can provide that a lithium secondary battery comprising:

a positive electrode comprising the positive electrode active material according to an embodiment of the present invention described above; a negative electrode comprising a negative active material; and an electrolyte positioned between the positive and negative electrodes.

The description related to the positive electrode active material will be omitted because it is the same as the one embodiment of the present invention described above.

The positive electrode active material layer may include a binder and a conductive material.

The binder well adheres the positive electrode active material particles to each other, and also serves to adhere the positive electrode active material well to the current collector.

The conductive material is used to impart conductivity to the electrode, and any electronic conductive material can be used without causing chemical change in the battery to be configured.

The negative electrode includes a current collector and a negative active material layer formed on the current collector, and the negative active material layer includes a negative active material.

The negative active material includes a material capable of reversible intercalation/deintercalation of lithium ion, lithium metal, an alloy of lithium metal, a material capable of doping and dedoping lithium, or a transition metal oxide.

A carbon material is a material that can intercalate/deintercalate the lithium ion in a reversible way. Any generally-used carbon-based negative active material in lithium ion secondary batteries can be used. Representative examples thereof include crystalline carbon, amorphous carbon, or a combination thereof.

The lithium metal alloy may be used as alloy of a lithium and a metal selected from the group consisting of Na, K, Rb, Cs, Fr, Be, Mg, Ca, Sr, Si, Sb, Pb, In, Zn, Ba, Ra, Ge, Al and Sn.

Materials capable of doping and dedoping the lithium include Si, SiOx (0<x<2), Si—Y alloy (the Y is an element selected from the group consisting of alkali metal, alkaline earth metal, group 13 element, group 14 element, transition metal, rare earth and combination thereof, and not Si), Sn, SnO₂, Sn—Y (the Y is an element selected from the group consisting of alkali metal, alkaline earth metal, group 13 element, group 14 element, transition metal, rare earth and combination thereof, and not Sn), etc.

Examples of the transition metal oxide include vanadium oxide and lithium vanadium oxide. The negative active material layer also includes a binder, and may optionally further include a conductive material.

The binder well adheres the negative active material particles to each other, and also serves to attach the negative active material to the current collector.

The conductive material is used to impart conductivity to the electrode, and any electronic conductive material can be used without causing chemical change in the battery to be configured.

As the current collector, one selected from the group consisting of copper foil, nickel foil, stainless steel foil, titanium foil, nickel foam, copper foam, a polymer substrate coated with conductive metal, and combination thereof may be used.

The negative electrode and the positive electrode are prepared by mixing an active material, a conductive material and a binder in a solvent to prepare an active material composition, and applying this composition to a current collector. Since such an electrode manufacturing method is widely known in the art, a detailed description will be omitted in this specification. As the solvent, N-methylpyrrolidone, etc. can be used, but is not limited thereto.

The electrolyte includes a non-aqueous organic solvent and lithium salt.

The non-aqueous organic solvent serves as a medium for ions involved in the electrochemical reaction of the battery to move.

The lithium salt is dissolved in an organic solvent and acts as a supply source of lithium ion in the battery, enabling basic lithium secondary battery operation, and accelerating the movement of lithium ions between the positive electrode and the negative electrode.

Depending on the type of lithium secondary battery, a separator may exist between the positive electrode and the negative electrode. As such a separator, polyethylene, polypropylene, polyvinylidene fluoride, or a multilayer of two or more layers thereof may be used. A mixed multilayer such as a polyethylene/polypropylene two-layer separator, a polyethylene/polypropylene/polyethylene three-layer separator, and a polypropylene/polyethylene/polypropylene three-layer separator may be used.

A lithium secondary battery can be classified into a lithium ion battery, a lithium ion polymer battery and a lithium polymer battery according to the type of separator and electrolyte used, and can be classified into cylindrical, prismatic, coin-type, pouch-type, etc. depending on the shape. According to the size, it can be divided into bulk type and thin film type. Since the structure and manufacturing method of these batteries are well known in this field, detailed descriptions are omitted.

Hereinafter, an embodiment of the present invention will be described in detail. However, this is provided as an example, and the present invention is not limited thereto, and the present invention is only defined by the scope of claims to be described later.

### (Exemplary embodiment 1) Preparation of Ni 88 mol % Positive Electrode Active Material

### 1) Preparation of Positive Electrode Active Material Precursor

NiSO₄.6H₂O was used as a raw material for nickel, CoSO₄.7H₂O was used as a raw material for cobalt, and MnSO₄.H₂O was used as a raw material for manganese. These raw materials were dissolved in distilled water to prepare a 2.5M aqueous metal salt solution.

After preparing the co-precipitation reactor, N₂ was purged to prevent oxidation of metal ions during the co-precipitation reaction, and the temperature of the reactor was maintained at 50° C.

In the co-precipitation reactor, an aqueous metal salt solution and NH₄(OH) as a chelating agent were added. In addition, NaOH was used to adjust the pH. The precipitate obtained according to the co-precipitation process was filtered, washed with distilled water, and dried in an oven at 100° C. for 24 hours to prepare a positive electrode active material precursor.

The composition of the prepared precursor was (Ni_{0.88}Co_{0.095}Mn_{0.025})(OH)₂, and the average particle diameter D50 was 14.8 μm.

### 2) Preparation of Positive Electrode Active Material

Based on 1 mole of the positive electrode active material precursor prepared in the step 1),

A mixture was prepared by uniformly mixing LiOH.H₂O (Samjeon Chemical, battery grade) 1.05 mol, Zr 3,400 ppm from ZrO₂ (Aldrich, 4N), and Al 280 ppm from Al(OH)₃ (Aldrich, 4N).

The mixture was charged into a tube furnace and calcined while oxygen was inflowed, cooled to room temperature, and then pulverized to prepare calcined powder.

Next, for the water washing process, 1 g of ammonium sulfate was added to 100 g of distilled water (D.I. water) and stirred for 1 minute to prepare a water washing solution.

100 g of the calcined powder was added to the washing solution, stirred for 10 minutes, and then filtered. After washing with water, the filtered sintered powder was dried in a chamber of 100° C. or higher, and heat treated at oxygen atmosphere and 400° C. for 3 hours to finally obtain a positive electrode active material.

### Exemplary Embodiments 2 to 7 and Comparative Example 1 and Reference Examples 1 to 2

A positive electrode active material was manufactured in the same manner as in Example 1, except that the composition of the washing solution and the heat treatment condition of the filtered sintered powder after washing with water were adjusted as described in Table 1 below.

TABLE 1

| | | heat treatment condition | |
|---|---|---|---|
| | | heat treatment | |
| | A composition of | temperature | Time |
| Division | washing liquid | (° C.) | (hr) |
| exemplary | 1 g of ammonium sulfate | 400 | 3 |
| embodiment 1 | 100 g of distilled water | | |
| exemplary | 5 g of ammonium sulfate | 400 | 3 |
| embodiment 2 | 100 g of distilled water | | |
| exemplary | 7 g of ammonium sulfate | 400 | 3 |
| embodiment 3 | 100 g of distilled water | | |
| exemplary | 10 g of ammonium sulfate | 400 | 3 |
| embodiment 4 | 100 g of distilled water | | |
| exemplary | 1 g of ammonium sulfate | 500 | 3 |
| embodiment 6 | 100 g of distilled water | | |
| exemplary | 1 g of ammonium sulfate | 600 | 3 |
| embodiment 7 | 100 g of distilled water | | |
| Comparative | 100 g distilled water | 400 | 3 |
| Example 1 | | | |
| Reference | 1 g of ammonium sulfate | 300 | 3 |
| Example 1 | 100 g of distilled water | | |
| Reference | 1 g of ammonium sulfate | 700 | 3 |
| Example 2 | 100 g of distilled water | | |
| exemplary | 1 g of ammonium manganese | 400 | 3 |
| embodiment 5 | sulfate 100 g of distilled | | |
| | water | | |

### (Experimental Example 1) FT-IR (Fourier-Transform Infrared Spectroscopy) Analysis

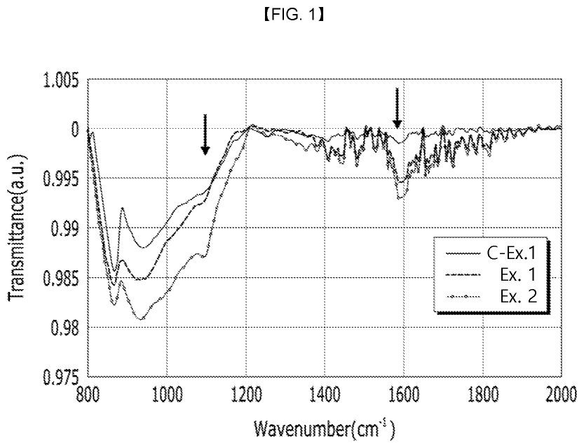

For the positive electrode active material manufactured according to exemplary embodiment 1 to 2 and Comparative Example 1, FT-IR (Fourier-transform infrared spectroscopy) is analyzed and the result is shown in FIG. 1.

Referring to the results of exemplary embodiment 1 and 2 in FIG. 1, it can be seen that the transmittance decreases as the ammonium sulfate content increases in the 1580 cm⁻¹ to 1600 cm⁻¹ wavelength region representing the N—H bend. In addition, the transmittance decreased as the content of ammonium sulfate increased in the wavelength region of the 1070 cm⁻¹ to 1120 cm⁻¹ range representing the S═O symmetric stretch. As such, when the transmittance measured in the coating layer of the positive electrode active material decreases due to an increase in the content of ammonium sulfate, the high temperature cycle-life characteristic of the lithium secondary battery can be remarkably improved.

On the other hand, in the case of the positive electrode active material prepared according to Comparative Example 1, where the coating layer was not formed by performing the washing process only with distilled water as in Comparative Example 1, a peak was observed in the wavelength region of 1580 cm⁻¹ to 1600 cm⁻¹, but almost no peak is observed in the wavelength region of 1070 cm⁻¹ to 1120 cm⁻¹.

### (Experimental Example 2) X-Ray Photoelectron Spectroscopy (XPS) Analysis

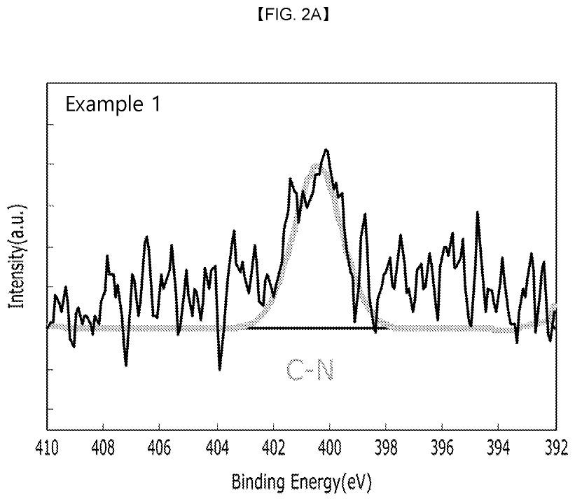

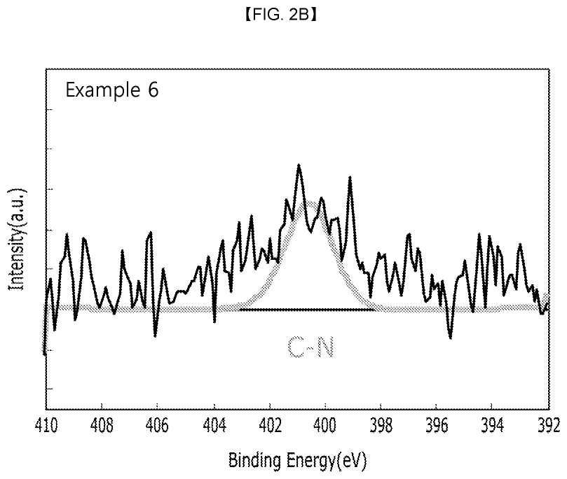

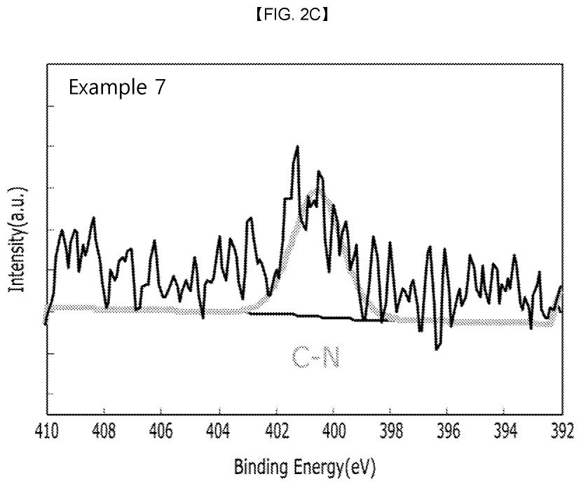

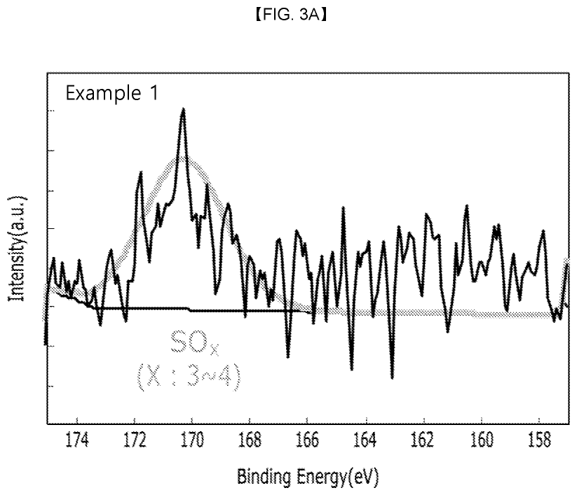

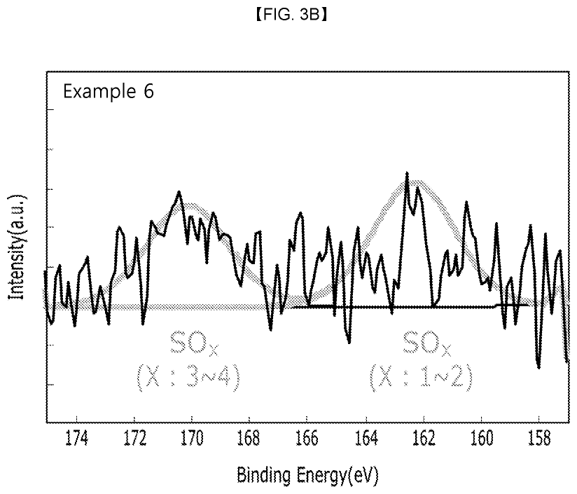

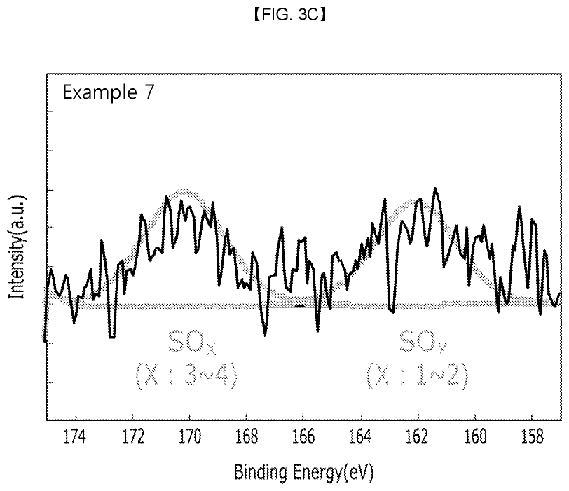

Analyzed by XPS (X-ray Photoelectron Spectroscopy) for the positive electrode active material manufactured according to exemplary embodiment 1 and exemplary embodiment 6 to 7, and the result is shown in FIG. 2A to FIG. 2C and FIG. 3A to FIG. 3C.

Referring to FIG. 2A to FIG. 2C, the N1s peak with a binding energy (Binding Energy) of 400.5 eV was observed as a C—N bond state. Also, referring to FIG. 3A to FIG. 3C, the S2p peak around 170.2 eV was observed in the SOx (x:3-4) binding state. Accordingly, it can be confirmed that the positive electrode active material according to the present exemplary embodiments includes a compound including a CN bond and a compound including a SOx bond in the coating layer.

### (Experimental Example 3) Average Particle Size Measurement of Positive Electrode Active Material

The average particle size (D50, μm) of the positive electrode active material prepared according to Comparative Example 1 and exemplary embodiment 1 to 7 and Reference Examples 1 to 2 was measured using a particle size analyzer. The results are shown in Table 2 below.

### (Experimental Example 4) Measurement of Specific Surface Area of Positive Electrode Active Material

For the positive electrode active material prepared according to

Comparative Example 1 and exemplary embodiment 1 to 4 and Reference Examples 1 to 2, a specific surface area was measured using a BET measuring instrument (QuantaChrome, Autosorb-iQ/MP). The results are shown in Table 2 below.

### (Experimental Example 5) X-Ray Diffraction (XRD) Analysis

For the positive electrode active material prepared according to Comparative Example 1, exemplary embodiment 1 to 7 and Reference Examples 1 to 2, the crystal grain size (crystalline size) was measured by X-ray diffraction measurement using CuKα rays, and the result was is shown in Table 2 below.

Referring to Table 2 below, in the case of the positive electrode active material according to exemplary embodiments 1 to 4, it can be confirmed that the average grain size satisfies the range of 111 nm to 140 nm.

### (Experimental Example 6) Electrochemical Characteristic Evaluation

After manufacturing a 2032 coin-type half cell using the positive electrode active material prepared according to Comparative Example 1, exemplary embodiment 1 to 7 and Reference Examples 1 to 2, electrochemical evaluation was performed.

### (1) Coin-Type Half-Cell Manufacturing

Specifically, positive electrode active material, polyvinylidene fluoride binder (trade name: KF1100) and Denka black conductive material were mixed at a weight ratio of 92.5:3.5:4. This mixture was added to N-methyl-2-pyrrolidone solvent so that the solid content was about 30 wt % to prepare a positive electrode active material slurry.

The slurry was coated on aluminum foil (Al foil, thickness: 15 μm), which is a positive electrode current collector, using a doctor blade (Doctor blade), dried and rolled to prepare a positive electrode. The loading amount of the positive electrode was about 14.6 mg/cm², and the rolling density was about 3.1 g/cm³.

A 2032 coin-type half-cell was prepared by a conventional method using the positive electrode, lithium metal negative electrode (thickness 200 μm, Honzo metal), electrolyte solution and polypropylene separator. The electrolyte solution is prepared by dissolving 1M LiPF₆ in a mixed solvent of ethylene carbonate, dimethyl carbonate and ethylmethyl carbonate (EMC) (mixing ratio EC:DMC:EMC=3:4:3 volume %), and then a vinyl carbonate (VC) was added1.5 wt % to the solution.

### (2) 45° C. High Temperature Cycle Characteristic Evaluation

The coin-type half-cell prepared in the (1) was aged at room temperature (25° C. for 10 hours), and then a charge and discharge test was performed.

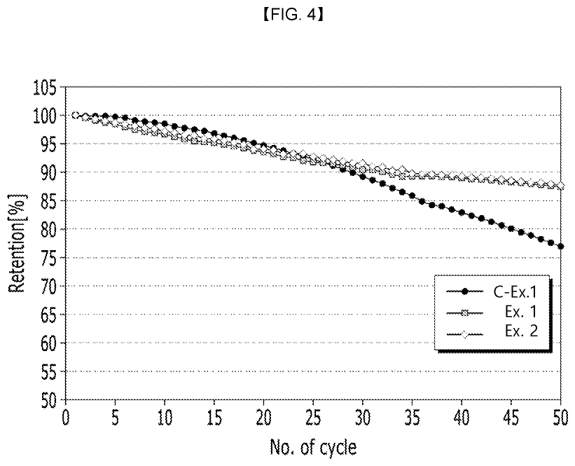

For capacity evaluation, 215 mAh/g was used as a standard capacity, and CC/CV 2.5-4.25V, 1/20 C cut-off was applied for charge and discharge conditions. Initial capacity was performed under 0.2 C charge/0.2 C discharge condition. The high-temperature cycle characteristic shows the 50th capacity retention rate compared to the first capacity after 50 measurements at 0.5 C charge/0.5 C discharge condition at high temperature 45° C. The results are in FIG. 4 and Table 2 below.

Referring to Table 2 and FIG. 4, in the case of exemplary embodiments 1 and 2 in which a coating layer including C—N and SOx (x:3-4) bonding exists on the positive electrode active material surface, compared with Comparative Example 1 in which such a coating layer is not formed that, it can be seen that the high temperature cycle characteristic increases significantly.

### (3) 25° C. Room Temperature Initial DC Resistance Characteristic Evaluation

The coin-type half-cell prepared in the (1) was aged at room temperature (25° C. for 10 hours), and then a charge and discharge test was performed.

For capacity evaluation, 215 mAh/g was used as a standard capacity, and CC/CV 2.5-4.25V, 1/20 C cut-off was applied for charge and discharge conditions. Initial capacity was performed under 0.2 C charge/0.2 C discharge condition. The initial DC resistance of room temperature was calculated by measuring the voltage fluctuation for 60 seconds after applying 0.2 C discharge current at 100% of 4.25V charge by 0.2 C, and it is shown in Table 2.

Referring to Table 2, compared to Comparative Example 1 in which no additive was used in the water washing process, in the case of Examples 1 to 7 and Reference Examples 1 and 2, in which the positive electrode active material was manufactured using an additive in the water washing process, it can be seen that the initial resistance all significantly decreased at room temperature. In particular, the initial resistance value for the positive electrode active material of exemplary embodiment 1 to 7 that the heat treatment temperature satisfies 400 to 600 degrees can be seen that it is more excellent when compared to the positive electrode active material of Reference Examples 1 and 2 manufactured under heat treatment conditions out of the range.

TABLE 2

| | | | | | | After high |
|---|---|---|---|---|---|---|
| | | | | | room | temperature |
| | | particle | specific | | temperature | 45° C. cycle, |
| | | size | surface | | initial DC | Capacity |
| | | [D50, | area | grain size | resistance | retention rate |
| Division | A | um] | [m²/g] | [nm] | [Ω] | [%] |
| Comparative | 0.216 | 15.0 | 0.95 | 110 | 36.1 | 76.9 |
| Example 1 | | | | | | |
| exemplary | 0.717 | 15.1 | 1.01 | 118 | 34.1 | 87.4 |
| embodiment 1 | | | | | | |
| exemplary | 0.544 | 15.1 | 0.99 | 116 | 34.3 | 87.7 |
| embodiment 2 | | | | | | |
| exemplary | 0.450 | 15.0 | 0.98 | 117 | 34.7 | 85.8 |
| embodiment 3 | | | | | | |
| exemplary | 0.412 | 15.1 | 0.99 | 116 | 35.5 | 85.1 |
| embodiment 4 | | | | | | |
| exemplary | — | 15.2 | 1.01 | 117 | 34.2 | 87.1 |
| embodiment 5 | | | | | | |
| exemplary | — | 15.0 | 1.01 | 117 | 34.3 | 86.9 |
| embodiment 6 | | | | | | |
| exemplary | — | 15.1 | 1.00 | 116 | 34.3 | 86.3 |
| embodiment 7 | | | | | | |
| Reference | — | 15.1 | 1.01 | 117 | 33.9 | 86.5 |
| Example 1 | | | | | | |
| Reference | — | 15.0 | 0.96 | 118 | 33.7 | 85.8 |
| Example 2 | | | | | | |

The present invention is not limited to the exemplary embodiments, but can be manufactured in a variety of different forms, and a person of an ordinary skill in the technical field to which the present invention belongs is without changing the technical idea or essential features of the present invention It will be understood that the invention may be embodied in other specific forms. Therefore, it should be understood that the exemplary embodiments described above are exemplary in all respects and not restrictive.

1. A positive electrode active material comprising:
a lithium metal oxide; and
a coating layer positioned on a surface of the lithium metal oxide;
wherein, the coating layer includes a first compound whose average transmittance of a peak, which is observed in the range of 1580 cm⁻¹ to 1600 cm⁻¹ by FT-IR measurement, is in the range of 0.990 to 0.998.

2. The positive electrode active material of claim 1, wherein:
the coating layer further includes a second compound whose average transmittance of a peak, which is observed in the range of 1070 cm⁻¹ to 1120 cm⁻¹ by FT-IR measurement, is in the range of 0.985 to 0.993.

3. The positive electrode active material of claim 2, wherein:
when A is a value obtained by dividing the absorbance average of the first compound by a absorbance average of the second compound, A satisfies Equation 1 below.
0.72>A=(an absorbance average of the first compound)/(an absorbance average of the second compound)>0.41 [Equation 1]
wherein (in the equation 1, the absorbance of the first compound is “1—the transmittance value of the first compound”, and the absorbance of the second compound is “1—the transmittance value of the second compound”.

4. The positive electrode active material of claim 1, wherein:
the first compound contains a CN bond.

5. The positive electrode active material of claim 2, wherein:
the second compound contains SOx bonds.

6. The positive electrode active material of claim 2, wherein:
in the coating layer, a peak was observed in at least one of 398 eV to 404 eV range, 166 eV to 173 eV range and 158 eV to 166 eV range, in the spectrum measured by X-ray photoelectron spectroscopy (XPS).

7. The positive electrode active material of claim 1, wherein:
a content of nickel in the lithium metal oxide is 80 mol % or more.

8. A manufacturing method of a positive electrode active material, comprising:
preparing a lithium metal oxide; and
forming a coating layer on a surface of the lithium metal oxide;
wherein, the coating layer includes a first compound whose average transmittance of a peak, which is observed in the range of 1580 cm⁻¹ to 1600 cm⁻¹ by FT-IR measurement, is in the range of 0.990 to 0.998.

9. The method of claim 8, wherein:
the step of forming the coating layer comprises washing the lithium metal oxide with water;
the step of washing the lithium metal oxide with water, is performed using a washing solution containing water and additives to form the coating layer.

10. The method of claim 9, wherein:
the additive is at least one of ammonium sulfate, ammonium cobalt sulfate hexahydrate, ammonium nickel sulfate, ammonium manganese sulfate, and aluminum ammonium sulfate.

11. The method of claim 9, wherein:
a content of the additive ranges from 1 wt % to 7wt % based on the washing solution.

12. The method of claim 9, wherein:
after the washing step, further comprising a step of heat treatment after drying the washed lithium metal oxide,
the heat treatment step is carried out in the 400° C. to 600° C. temperature range for 3 to 10 hours.

13. A lithium secondary battery comprising:
a positive electrode comprising the positive electrode active material according to claim 1;
a negative electrode comprising a negative active material; and
an electrolyte positioned between the positive and negative electrodes.
